(19) United States
(12) Patent Application Publication
(10) Pub. No.: US 2009/0247703 A1
(43) Pub. Date: Oct. 1, 2009

(54) PROCESS FOR IMPROVING TEAR RESISTANCE IN ELASTIC FILMS

(76) Inventor: DALE L. HANDLIN, JR., Houston, TX (US)

Correspondence Address: KRATON POLYMERS U.S. LLC, 16400 Park Row, HOUSTON, TX, 77084, US

(21) Appl. No.: 12/058,108

(22) Filed: Mar. 28, 2008

(51) Int. Cl. C08L 9/06; C08L 9/00

(52) U.S. Cl. 525/99

(57) ABSTRACT

The present invention relates to a process for improving the tear resistance of elastic films. The process includes novel compositions comprising (a) an anionic block copolymer of mono alkenyl arenes and conjugated dienes, (b) a monoalkenyl arene polymer prepared via an anionic polymerization process and (c) a rubber softening modifier, which composition results in a surprising improvement in properties for the composition.

### FIELD OF THE INVENTION

This invention relates to a process for improving tear resistance in elastic films. The films are prepared by blending (a) an anionically polymerized hydrogenated block copolymer of mono alkenyl arenes and conjugated dienes, (b) an anionically polymerized monoalkenyl arene homopolymer and (c) a rubber softening modifier, and extruding the blend into films which results in a surprising improvement in properties.

### BACKGROUND OF THE INVENTION

The preparation of block copolymers is well known. In a representative synthetic method, an initiator compound is used to start the anionic polymerization of one monomer. The reaction is allowed to proceed until all of the monomer is consumed, resulting in a living homopolymer. To this living homopolymer is added a second monomer that is chemically different from the first. The living end of the first polymer serves as the site for continued polymerization, thereby incorporating the second monomer as a distinct block into the linear polymer. The block copolymer so grown is living until terminated.

Termination converts the living end of the block copolymer into a non-propagating species, thereby rendering the polymer non-reactive toward monomer or coupling agent. A polymer so terminated is commonly referred to as a diblock copolymer. If the polymer is not terminated the living block copolymers can be reacted with additional monomer to form a sequential linear tri-block copolymer. Alternatively the living block copolymer can be contacted with multifunctional agents commonly referred to as coupling agents. Coupling two of the living ends together results in a linear triblock copolymer having twice the molecular weight of the starting, living, diblock copolymer. Coupling more than two of the living diblock copolymer regions results in a radial block copolymer architecture having at least three arms.

One of the first patents on linear ABA block copolymers made with styrene and butadiene is U.S. Pat. No. 3,149,182. These polymers in turn could be hydrogenated to form more stable block copolymers, such as those described in U.S. Pat. Nos. 3,595,942 and Re. 27,145. Various other block copolymers and processes for making them have been proposed over the years.

Such block copolymers are usually compounded with other components in order to make useful articles. Common blending components include plasticizing oils, tackifying resins, polymers, oligomers, fillers, reinforcements and additives of all varieties. The particular components in the compound are chosen to achieve the necessary performance requirements for the specific end use. For example, the key performance properties of elastic films and fibers used in personal care applications such as diapers, training pants, adult incontinence products, etc., are the strength (and tear resistance), hysteresis recovery, and stress relaxation. It is important that the compound be strong with high elongation and tear resistant so that it does not break when stretched to application targets. It is important that the hysteresis recovery be as high as possible so that the film has an elastic feel and returns to its initial shape after stretching. In other words a consumer's view of elasticity can be closely associated with immediate hysteresis recovery. It is also important that the stress produced by stretching is retained by the film and does not relax excessively during the use period. For example, garments containing materials with low stress relaxation will tend to remain in place during wearing rather than sagging over time.

Processing properties are equally important so that films, fibers, laminates and the resulting articles can be made continuously and at high process speeds without defects or breaking. For example, an appropriate viscosity is important to assure that the compound can be extruded in a temperature range that is between 150 and 300° C. using common extruders and dies typically found in the industry. Such a viscosity would typically be between 10,000 and 1,000,000 Pa-sec at processing temperature. Another key property for processing is high speed tear resistance. Film and fiber processing often exceeds 1000 ft/minute so the ability to avoid tearing at those speeds is crucial to continuous, stable operation. It is also important that the tear strength is high even in the presence of a notch, or cut in the film or fiber. Even materials with high strength at room temperature and normal testing speed, for example 25 mm/minute, may fail at low stress and elongation at higher speeds with a notch.

What has long been sought is an elastic material with high strength, high elastic recovery, low stress relaxation and high tear strength at high speed in the presence of a notch. The prior art blends of selectively hydrogenated block copolymers, such as S-EB-S block copolymers, with crystal polystyrene and oil can achieve high strength, good hysteresis and good processability. However, they have modest tear strengths at high speed when notched. Applicants have now discovered a novel compound with such selectively hydrogenated block copolymers that shows significant and surprising property advantages over the prior art.

### SUMMARY OF THE INVENTION

The invention claimed here is a significant improvement over the prior art process for making elastic films with acceptable tear resistance based on compounds with S-EB-S type block copolymers. The present invention is based on the discovery that when the polystyrene is made by anionic polymerization (as opposed to the free radical process used in making commercial crystal polystyrene) in a particular in-situ type polymerization scheme, the high speed notched tear strength is surprisingly improved. An additional and unexpected beneficial property is a significant reduction in odor compared to the use of commercial polystyrene. This is a very beneficial feature for consumer personal care products to be used in contact with the body.

Tear strength is a very important commercial property in the resulting compound. In the past, compounders and polymer manufacturers used the Elmendorf tear testing as described in ASTM D-1922 as being indicative of good tear strength. Although an important measurement of tear resistance, the Elmendorf tear test is not conducted at a high enough speed to assure good high speed processability. Accordingly, a unique high speed tensile test developed by Prof Alan Lesser at the University of Massachusetts was used to determine the tear strength and energy at speeds approaching 4 meters/second. In this test a sample 12.7 mm wide and 19.05 mm long is clamped between a stationary grip and a movable grip. For the notched test a razor cut is made in the sample to ¼ of its width. As shown in FIG. 1, the sample and grips are positioned beneath a pendulum. The pendulum is released and as it reaches its maximum speed, it picks up the movable clamp thereby stretching the sample to break at a rate of 3.95 meters/second. The sample and movable clamp have low mass, and therefore do not appreciably slow the pendulum. In the most severe test a 5 mm razor notch is cut in the film before clamping. Two quantities are measured by the test: 1. the total energy to rupture of the sample, which is how much energy the sample absorbed during stretching and tearing, and 2. the strength of the sample, which is the maximum stress recorded during the test. The compounds of the present invention have a high speed notched tear strength significantly better than the prior art when notched. For example, the Rupture Energy for compounds of the present invention is greater than 10 kJ/m³×1000, and preferably greater than 12 kJ/m³. The notched Tensile Strength is more than 5 MPa and preferably greater than 6 MPa.

Accordingly, the present invention is a process for improving the tear resistance of elastic films comprising (a) blending 40 to 80 parts by weight of a selectively hydrogenated block copolymer, 5 to 30 parts by weight of a monoalkenyl arene polymer prepared by anionic polymerization and 0 to 50 parts by weight of a rubber softening modifier, and (b) extruding a plastic film from the resulting blend at a temperature of 150° to 300° C. and a viscosity of 10,000 to 1,000,000 Pa-sec at extrusion temperature, wherein the resulting film has a Rupture Energy over 10 kJ/m3×1000, and a Tensile Strength more than 6 MPa according to the Lesser test measured at a rate of more than 3 meters/second (termed the “high speed tensile test”).

The base polymer used in the present invention is a selectively hydrogenated block copolymer having the general configuration A-B-A, A-B-A-B, (A-B)n, (A-B-A)n, (A-B-A)nX, (A-B)nX or mixtures thereof, where n is an integer from 2 to about 30, and X is coupling agent residue, which polymer is prepared by anionic polymerization and wherein:
(i) prior to hydrogenation each A block is a mono alkenyl arene polymer block and each B block is a conjugated diene block having a vinyl content between 5 weight percent and 85 weight percent;
(ii) subsequent to hydrogenation about 0-10% of the arene double bonds have been reduced, and at least about 90% of the conjugated diene double bonds have been reduced;
(iii) each A block having a number average molecular weight between about 3,000 and about 20,000 and each B block or coupled B block having a number average molecular weight between about 20,000 and about 200,000; and
(iv) the total amount of mono alkenyl arene in the hydrogenated block copolymer is about 10 percent weight to about 40 percent weight.
   An essential aspect of the present invention is that one must use a monoalkenyl arene polymer made by an anionic polymerization process (“APS” or “anionic polystyrene”), and having a number average molecular weight of between 5,000 and 150,000 and a ratio of the molecular weight of the APS to the A block molecular weight of greater than 1.2, preferably 1.2 to 50. This is a surprising discovery, since the prior art suggests that the molecular weight of the polystyrene should be 1:1 or less in order to incorporate the polystyrene into the block copolymer. However, as shown in the examples, a ratio of 1.2 to 50 improves properties, such as Elmendorf tear strength, in the resulting products. In addition the molecular weight distribution (“Q” value or weight average molecular weight (MW_{W}) divided by number average molecular weight (MWₙ)) of the APS is between 1 and 1.5. In addition the level of residual monomer and dimer is less than 0.1 weight percent.

In the Examples which follow, the specific block copolymer used was an S-EB-S block copolymer with true molecular weights of 9,500-42,500-9,500 made by hydrogenating a styrene-butadiene-styrene block copolymer, where the butadiene prior to hydrogenation had a 1,2 vinyl content of 38%. This block copolymer was blended in solution with various anionic polystyrene homopolymers (“APS”) of varying molecular weight. In the Examples the APS had molecular weights of 10,000, 14,000, 50,000 and 100,000. The compounds and comparison compounds are shown in Tables #3 and 4 below. As shown in the Examples, the use of APS instead of crystal polystyrene produced compounds having much higher strength and hysteresis, along with an improvement in odor.

It is important that the particular compositions of the present invention are “in-situ compositions”, since the anionically polymerized monoalkenyl arene homopolymer is made and/or finished “in-situ”, along with the selectively hydrogenated block copolymer. This “in-situ” recovery is important since it produces a very uniform dispersion and further provides much higher strength and hysteresis recovery in the final compound. The blend can thus be recovered as an easy to handle solid. Further, this method of manufacture also serves to simplify the compound formation since in certain cases only oil needs to be added to complete the compound, thereby leading to simpler and more reproducible compounding.

The monoalkenyl arene homopolymer/block copolymer blend may be prepared before recovery from the manufacturing solvent by 1) combining separate process streams containing the individual components—monoalkenyl arene polymer and base block copolymer or 2) preparing them in the same process stream. The two approaches have different advantages. When the two components are polymerized separately and the solvent blend is prepared by mixing prior to finishing, there are few constraints on the chemistry that may be used to make the APS or the base polymer. Another approach may be to take the selectively hydrogenated block copolymer and redissolve it in an appropriate solvent, and then combine it with a solution of the monoalkenyl arene polymer, and finish the two together.

Accordingly, the present invention for making the block copolymer composition used in the claimed process when employing two separate reactor systems broadly comprises a novel block copolymer composition comprising:

(a) 40 to 80 parts by weight of a solid selectively hydrogenated block copolymer having the general configuration A-B-A, A-B-A-B, (A-B)n, (A-B-A)n, (A-B-A)nX, (A-B)nX or mixtures thereof, where n is an integer from 2 to about 30, and X is coupling agent residue and wherein:
(i) prior to hydrogenation each A block is a mono alkenyl arene polymer block and each B block is a conjugated diene block having a vinyl content (V) between 5 weight percent and 85 weight percent;
(ii) subsequent to hydrogenation about 0-10% of the arene double bonds have been reduced, and at least about 90% of the conjugated diene double bonds have been reduced;
(iii) each A block having a number average molecular weight between about 3,000 and about 20,000 and each B block or coupled B block having a number average molecular weight between about 20,000 and about 200,000; and
(iv) the total amount of mono alkenyl arene in the hydrogenated block copolymer is about 10 percent weight to about 40 percent weight; and

(b) 5 to 30 parts by weight of a monoalkenyl arene polymer prepared by anionic polymerization wherein:
(i) said monoalkenyl arene polymer has a number average molecular weight of 5,000 to 200,000; and
(ii) ratio of the molecular weight of said monoalkenyl arene polymer to the molecular weight of the A block is at least 1.2; and
(iii) said molecular weight distribution is between 1 and 1.5 wherein the weight average molecular weight (MWw) is divided by the number average molecular weight (MWₙ);

(c) 0 to 50 parts by weight of a rubber softening modifier, the total composition containing 100 parts by weight; and

(d) wherein said selectively hydrogenated block copolymer is formed in solution in the presence of a solvent in a first reactor to form a first solution and said monoalkenyl arene polymer is formed in solution in the presence of a solvent in a second reactor to form a second solution;

(e) said first and second solutions are combined to form a common solution; and

(f) the solvent is removed from the common solution, providing an intimate mixture of said selectively hydrogenated block copolymer and said monoalkenyl arene polymer.

When the monoalkenyl arene polymer is made originally in a separate reactor and in a separate solution, there are a number of means to combine the solutions and obtain the particular in-situ composition. These include:
1. combining the first solution and second solutions after polymerization of both components prior to hydrogenation, hydrogenating the combined selectively hydrogenated block copolymer and monoalkenyl arene polymer in the common solution, and recovering the combined product in a finishing step;
2. combining the first solution and second solution after polymerization of both components and after hydrogenation, and then finishing the solvent blend;
3. adding the second solution to the first solution prior to polymerization of the selectively hydrogenated block copolymer, and then continuing with polymerization, hydrogenation and finishing;
4. adding the second solution to the first solution during the polymerization of the selectively hydrogenated block copolymer, followed by hydrogenation and finishing; or
5. redissolving a solid selectively hydrogenated block copolymer in a solvent to form a first solution, polymerizing the monoalkenyl arene polymer in a second solution, combining the first and second solutions, and then finishing the solvent blend.
   Alternatively, it is possible to make the particular composition in a single reactor. In this case, the composition comprises:

(a) 40 to 80 parts by weight of a solid selectively hydrogenated block copolymer having the general configuration A-B-A, A-B-A-B, (A-B)ₙ, (A-B-A)ₙ, (A-B-A)ₙX, (A-B)ₙX or mixtures thereof, where n is an integer from 2 to about 30, and X is coupling agent residue and wherein:
(i) prior to hydrogenation each A block is a mono alkenyl arene polymer block and each B block is a conjugated diene block having a vinyl content (V) between 5 weight percent and 85 weight percent;
(ii) subsequent to hydrogenation about 0-10% of the arene double bonds have been reduced, and at least about 90% of the conjugated diene double bonds have been reduced;
(iii) each A block having a number average molecular weight between about 3,000 and about 20,000 and each B block or coupled B block having a number average molecular weight between about 20,000 and about 200,000; and
(iv) the total amount of mono alkenyl arene in the hydrogenated block copolymer is about 10 percent weight to about 40 percent weight; and

(b) 5 to 30 parts by weight of a monoalkenyl arene polymer prepared by anionic polymerization wherein:
(i) said monoalkenyl arene polymer has a number average molecular weight of 5,000 to 200,000; and
(ii) ratio of the molecular weight of said monoalkenyl arene polymer to the molecular weight of the A block is at least 1.2; and
(iii) said molecular weight distribution is between 1 and 1.5 wherein the weight average molecular weight (MWw) is divided by the number average molecular weight (MWₙ); and

(c) 0 to 50 parts by weight of a rubber softening modifier, the total composition containing 100 parts by weight; and

(d) wherein said selectively hydrogenated block copolymer is formed in solution in a reactor in the presence of a solvent to form a solution and said monoalkenyl arene polymer is formed in the same solution in the same reactor; and

(e) the solvent is removed from the solution, providing an intimate mixture of said selectively hydrogenated block copolymer and said monoalkenyl arene polymer. In this case, where a single reactor is employed, the alternatives include varying the order of polymerization, wherein:
1. the APS is polymerized prior to the selectively hydrogenated block copolymer; or
2. the APS is polymerized after the selectively hydrogenated block copolymer.
   Details regarding the particular selectively hydrogenated block copolymers and monoalkenyl arene polymers, along with the processes for making them are described further below.

### BRIEF DESCRIPTION OF THE DRAWING

FIG. 1 shows a schematic of the instrument used to measure tensile strength on polymeric films at high strain rates. The instrument is a modified Charpy device, and consists of a movable and a fixed clamp. The fixed clamp is a cantilever beam, used as a load cell.

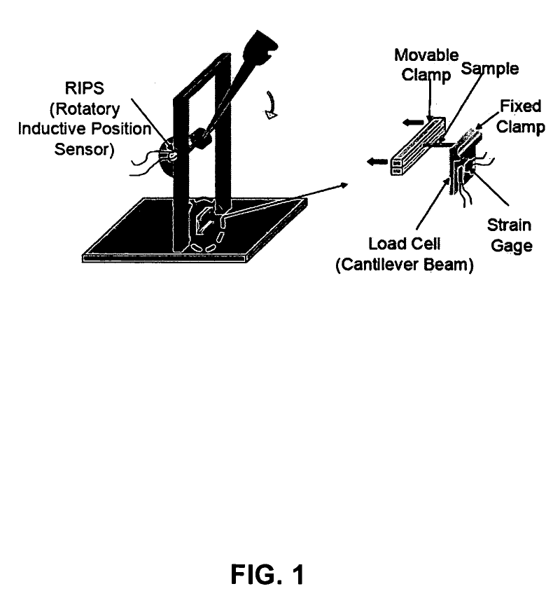

### DETAILED DESCRIPTION OF THE INVENTION

The present invention offers a process for making films having improved tear strength, based on novel compositions and methods of preparing such compositions. The three basic components in the novel compositions are (a) a selectively hydrogenated block copolymer, (b) an anionically polymerized monoalkenyl arene polymer, and (c) a rubber softening modifier.

1. Selectively Hydrogenated Block Copolymers

The selectively hydrogenated block copolymer is described and claimed in U.S. Pat. No. 27,145. Regarding the particular parameters of the selectively hydrogenated block copolymer used in the present invention, the selectively hydrogenated block copolymer has the general configuration A-B-A, A-B-A-B, (A-B)ₙ, (A-B-A)ₙ, (A-B-A)ₙX, (A-B)ₙX or mixtures thereof, where n is an integer from 2 to about 30, and X is coupling agent residue and wherein:
(i). prior to hydrogenation each A block is a mono alkenyl arene polymer block and each B block is a conjugated diene block having a vinyl content (V) between 5 weight percent and 85 weight percent;
(ii) subsequent to hydrogenation about 0-10% of the arene double bonds have been reduced, and at least about 90% of the conjugated diene double bonds have been reduced;
(iii) each A block having a number average molecular weight between about 3,000 and about 20,000 and each B block or coupled B block having a number average molecular weight between about 20,000 and about 200,000; and
iv. the total amount of mono alkenyl arene in the hydrogenated block copolymer is about 10 percent weight to about 40 percent weight.
   The following are preferred ranges for the various properties of the selectively hydrogenated block copolymer:
The mono alkenyl arene is styrene, alpha-methylstyrene, para-methylstyrene, vinyl toluene, vinylnaphthalene, diphenyl ethylene, and para-butyl styrene, more preferably styrene;
The conjugated diene is preferably 1,3-butadiene, isoprene or mixtures thereof, more preferably 1,3-butadiene;
The structure is either a linear A-B-A block copolymer, an A-B-A-B tetrablock copolymer or a radial (A-B)ₙX block copolymer where n is 2 to 6. For certain applications, a linear block copolymer is preferred, while for other applications, a radial or branched block copolymer is preferred. It is also possible to have a combination of a linear block copolymer and a radial block copolymer;
Subsequent to hydrogenation about 0-5% of the arene double bonds have been reduced, and at least about 95% of the conjugated diene double bonds have been reduced;
Each A block preferably has a peak number average molecular weight between about 3,000 and about 20,000, more preferably between about 5,000 and 15,000, and each B block preferably has a peak number average molecular weight between about 20,000 and about 200,000, preferably 30,000 to 100,000. These numbers are for a linear sequential block copolymer. If the block copolymer is a radial block copolymer or a coupled the molecular weights of each B block will be half—i.e. 10,000 to 100,000, and the coupled block copolymer will have a B block of essentially 20,000 to 200,000;
The total amount of mono alkenyl arene in the hydrogenated block copolymer is preferably about 10 percent weight to about 40 percent weight, more preferably about 10 to about 25 percent weight.

2. Anionically Polymerized Monoalkenyl Arene Polymer

The monoalkenyl arene polymer used with the selectively hydrogenated block copolymer is structurally related to the character of the A block of the selectively hydrogenated block copolymer in that both are made via anionic polymerization. The following are the necessary features of the anionically polymerized monoalkenyl arene polymer:
(i) the peak number average molecular weight must be between 5,000 and 125,000;
(ii) the monoalkenyl arene monomer will be selected from styrene, alpha-methylstyrene, para-methylstyrene, vinyl toluene, vinylnaphthalene, and para-butyl styrene, preferably styrene;
(iii) the ratio of the molecular weight of said monoalkenyl arene polymer to the molecular weight of the A block is at least 1.2; and
(iv) the molecular weight distribution (“Q” value or weight average molecular weight (MWw) divided by number average molecular weight (MWn)) is between 1 and 1.5.

The following are preferred ranges for the properties of the monoalkenyl arene polymer:
the peak number average molecular weight is preferably 7,000 to 100,000;
the ratio of the monoalkenyl arene polymer molecular weight to the A block is between 1.2 and 20.
the Q value is between 1 and 1.2; and
the content of total residual monomer and dimer will be less than 0.1 weight percent, therein resulting in improved odor for the composition.

3. Overall Process to Make Selectively Hydrogenated Block Copolymer and Monoalkenyl Arene Polymer

Anionic, solution co-polymerization to form the selectively hydrogenated block copolymers and monoalkenyl arene polymers of the present invention can be carried out using, to a great extent, known and previously employed methods and materials. In general, the co-polymerization is attained anionically, using known selections of adjunct materials, including polymerization initiators, solvents, promoters, and structure modifiers. In some cases, particularly where the vinyl content of the conjugated diene is to be over 50%, it may be necessary to use a chelating agent, including dialkyl ethers of ethylene glycol and aliphatic polyethers such as diethylene glycol dimethyl ether and diethylene glycol diethyl ether.

An important aspect of the present invention is to control the microstructure or vinyl content of the conjugated diene in the selectively hydrogenated copolymer block B. The term “vinyl content” refers to the fact that a conjugated diene is polymerized via 1,2-addition (in the case of butadiene—it would be 3,4-addition in the case of isoprene). Although a pure “vinyl” group is formed only in the case of 1,2-addition polymerization of 1,3-butadiene, the effects of 3,4-addition polymerization of isoprene (and similar addition for other conjugated dienes) on the final properties of the block copolymer will be similar. The term “vinyl” refers to the presence of a pendant vinyl group on the polymer chain. When referring to the use of butadiene as the conjugated diene, it is preferred that about 20 to about 85 mol percent of the condensed butadiene units in the copolymer block have 1,2 vinyl configuration as determined by proton NMR analysis. For selectively hydrogenated block copolymers, preferably about 30 to about 82 mol percent of the condensed butadiene units should have 1,2 configuration. For isoprene the vinyl content will be preferably less than 20 weight percent, preferably less than 10 weight percent. This is effectively controlled by varying the relative amount of the microstructure modifying agent. Suitable ratios of microstructure agent to lithium are disclosed and taught in U.S. Pat. No. Re 27,145, which disclosure is incorporated by reference.

The solvent used as the polymerization vehicle may be any hydrocarbon that does not react with the living anionic chain end of the forming polymer, is easily handled in commercial polymerization units, and offers the appropriate solubility characteristics for the product polymer. For example, non-polar aliphatic hydrocarbons, which are generally lacking in ionizable hydrogens make particularly suitable solvents. Frequently used are cyclic alkanes, such as cyclopentane, cyclohexane, cycloheptane, and cyclooctane, all of which are relatively non-polar. Other suitable solvents will be known to one skilled in the art and can be selected to perform effectively in a given set of process conditions, with temperature being one of the major factors taken into consideration.

Starting materials for preparing the novel selectively hydrogenated copolymers and monoalkenyl arene polymers of the present invention include the initial monomers. The alkenyl arene can be selected from styrene, alpha-methylstyrene, para-methylstyrene, vinyl toluene, vinylnaphthalene, diphenyl ethylene, and para-butyl styrene or mixtures thereof. Of these, styrene is most preferred and is commercially available, and relatively inexpensive, from a variety of manufacturers. In certain cases, it is preferred that the alkenyl arene used for the A blocks be alpha-methylstyrene or a mixture of alpha-methylstyrene and styrene or a mixture of diphenyl ethylene and styrene. In that case, the end blocks will have a higher Tg or glass transition temperature. The conjugated dienes for use herein are 1,3-butadiene and substituted butadienes such as isoprene, piperylene, 2,3-dimethyl-1,3-butadiene, and 1-phenyl-1,3-butadiene, or mixtures thereof. Of these, 1,3-butadiene and 1,3 isoprene are most preferred. As used herein, and in the claims, “butadiene” and “isoprene” refers specifically to “1,3-butadiene” and “1,3-isoprene”.

Other important starting materials for anionic co-polymerizations include one or more polymerization initiators. In the present invention such include, for example, alkyl lithium compounds and other organolithium compounds such as s-butyllithium, n-butyllithium, t-butyllithium, amyllithium and the like, including di-initiators such as the di-sec-butyl lithium adduct of m-diisopropenyl benzene. Other such di-initiators are disclosed in U.S. Pat. No. 6,492,469. Of the various polymerization initiators, s-butyllithium is preferred. The initiator can be used in the polymerization mixture (including monomers and solvent) in an amount calculated on the basis of one initiator molecule per desired polymer chain. The lithium initiator process is well known and is described in, for example, U.S. Pat. No. 4,039,593 and Re. 27,145, which descriptions are incorporated herein by reference.

Polymerization conditions to prepare the copolymers of the present invention are typically similar to those used for anionic polymerizations in general. In the present invention polymerization is preferably carried out at a temperature of from about −30° to about 150° C., more preferably about 10° to about 100° C., and most preferably, in view of industrial limitations, about 30° to about 90° C. It is carried out in an inert atmosphere preferably nitrogen, and may also be accomplished under pressure within the range of from about 0.5 to about 10 bars. This polymerization generally requires less than about 12 hours, and can be accomplished in from about 5 minutes to about 5 hours, depending upon the temperature, the concentration of the monomer components, the molecular weight of the polymer and the amount of distribution agent that is employed.

As used herein, “thermoplastic block copolymer” is defined as a block copolymer having at least a first block of one or more mono alkenyl arenes, such as styrene and a second block of a selectively hydrogenated polymer of one or more dienes. The method to prepare this thermoplastic block copolymer is via any of the methods generally known for block polymerizations. The present invention includes as an embodiment a thermoplastic copolymer composition, which may be a tri-block copolymer, tetra-block copolymer or multi-block composition. In the case of the tri-block composition, it comprises, as end-blocks the glassy alkenyl arene-based homopolymer and as a mid-block the selectively hydrogenated diene. Where a tri-block copolymer composition is prepared, the selectively hydrogenated diene polymer can be herein designated as “B” and the alkenyl arene-based homopolymer designated as “A”. The A-B-A, tri-block compositions can be made by either sequential polymerization or coupling. In addition to the linear, A-B-A configuration, the blocks can be structured to form a radial (branched) polymer, (A-B)nX, or both types of structures can be combined in a mixture. Some A-B diblock polymer can be present but preferably at least about 80 weight percent of the block copolymer is A-B-A or radial (or otherwise branched so as to have 2 or more terminal resinous blocks per molecule) so as to impart strength.

Preparation of radial (branched) polymers requires a post-polymerization step called “coupling”. It is possible to have either a branched selectively hydrogenated block copolymer and/or a branched monoalkenyl arene polymer. In the above radial formula for the selectively hydrogenated block copolymer, n is an integer of from 2 to about 30, preferably from about 2 to about 15, and X is the remnant or residue of a coupling agent. A variety of coupling agents are known in the art and include, for example, dihalo alkanes, silicon halides, siloxanes, multifunctional epoxides, silica compounds, esters of monohydric alcohols with carboxylic acids, (e.g. dimethyl adipate) and epoxidized oils. Star-shaped polymers are prepared with polyalkenyl coupling agents as disclosed in, for example, U.S. Pat. Nos. 3,985,830; 4,391,949; and 4,444,953; Canadian Patent Number 716,645. Suitable polyalkenyl coupling agents include divinylbenzene, and preferably m-divinylbenzene. Preferred are tetra-alkoxysilanes such as methyl, tri-methoxysilane, tetra-ethoxysilane (TEOS), aliphatic diesters such as dimethyl adipate and diethyl adipate, and diglycidyl aromatic epoxy compounds such as diglycidyl ethers deriving from the reaction of bis-phenol A and epichlorohydrin.

Additional possible post-polymerization treatments that can be used to further modify the configuration of the polymers includes chain-termination. Chain termination simply prevents further polymerization and thus prevents molecular weight growth beyond a desired point. This is accomplished via the deactivation of active metal atoms, particularly active alkali metal atoms, and more preferably the active lithium atoms remaining when all of the monomer has been polymerized. Effective chain termination agents include water; alcohols such as methanol, ethanol, isopropanol, 2-ethylhexanol, mixtures thereof and the like; and carboxylic acids such as formic acid, acetic acid, maleic acid, mixtures thereof and the like. See, for example, U.S. Pat. No. 4,788,361, the disclosure of which is incorporated herein by reference. Other compounds are known in the prior art to deactivate the active or living metal atom sites, and any of these known compounds may also be used.

It is also important to control the molecular weight of the various blocks. As used herein, the term “molecular weight” refers to the true molecular weight in g/mol of the polymer of block of the copolymer. The molecular weights referred to in this specification and claims can be measured with gel permeation chromatography (GPC) using polystyrene calibration standards, such as is done according to ASTM 3536. GPC is a well-known method wherein polymers are separated according to molecular size, the largest molecule eluting first. The chromatograph is calibrated using commercially available polystyrene molecular weight standards. The molecular weight of polymers measured using GPC so calibrated are styrene equivalent molecular weights. The styrene equivalent molecular weight may be converted to true molecular weight when the styrene content of the polymer and the vinyl content of the diene segments are known. The detector used is preferably a combination ultraviolet and refractive index detector. The molecular weights expressed herein are measured at the peak of the GPC trace, converted to true molecular weights, and are commonly referred to as “peak molecular weights”.

4. Separate Reactor Process to Make Components

One alternative to prepare the in-situ compositions of the present invention is to polymerize the monoalkenyl arene polymer separately from the selectively hydrogenated block copolymer in a separate reactor. The following alternatives are thus possible:

a) Addition of the Monoalkenyl Arene Polymer Solution Before or During the Preparation of the Selectively Hydrogenated Block Copolymer

Optionally, the solution of monoalkenyl arene polymer in its polymerization solvent could be used as the solvent for the synthesis of the selectively hydrogenated block copolymer. In this scheme, the monoalkenyl arene polymer is in essence replacing some of the solvent that would have been used had the selectively hydrogenated block copolymer been made in the usual way. When the solution of the blend is finished, more product, base block copolymer plus APS, will be generated per pound of solution than would have been realized had the base block copolymer been prepared in the normal way. The efficiency of the polymerization process has been enhanced.

b) Addition of Monoalkenyl Arene Polymer Solution After the Preparation of the Base Block Copolymer

The selectively hydrogenated block copolymer might be prepared before the addition of the solution of the monoalkenyl arene polymer and the two streams could be blended prior to other polymer treatment steps such as hydrogenation, or wash or addition of antioxidants. Such a process would benefit from not having to apply these post-polymerization techniques to two separate streams.

c) Addition of Monoalkenyl Arene Polymer Solution Just Prior to Finishing

Even if the solutions of the selectively hydrogenated block copolymer and the monoalkenyl arene polymer are only combined immediately before the solvent removal step, this process benefits from the ease of being able to prepare the two components by the methods that are best suited to each of them. The two polymerization processes are not constrained to only those processing conditions that are compatible with both preparations. A robust process is envisioned. Also, a more energy efficient removal process may be realized since the blend would be at a higher solids content than the initial block copolymer solution itself.

d) Addition of Monoalkenyl Arene Polymer Solution to a Solution of Redissolved Selectively Hydrogenated Block Copolymer, and then Finishing

In this example, a solid selectively hydrogenated block copolymer is redissolved in an appropriate solvent, and is then combined with the solution of the monoalkenyl arene polymer prior to finishing both materials together.

5. Single Reactor Process to Make Components

On the other hand, preparation of the monoalkenyl arene polymer and the selectively hydrogenated block copolymer in the same reactor obviates the need for a second polymerization vessel and the associated process control equipment. In this approach, equipment costs could be substantially reduced. Not wishing to be limited to the process concepts described below, the following examples are offered as illustrations of how this approach could be practiced.

a) Preparation of the Monoalkenyl Arene Polymer Prior to the Preparation of the Selectively Hydrogenated Block Copolymer

This approach is similar to that outlined above for the (a) case except that after the monoalkenyl arene polymer is prepared and terminated in solution more initiator is added and the block copolymer is prepared in the same reactor already containing the monoalkenyl arene polymer. Thus the monoalkenyl arene polymer is used to replace part of the solvent for the preparation of the block copolymer. All of the efficiencies of that process would be realized with the added benefit that only one vessel would be used in the present example.

b) Preparation of the Monoalkenyl Arene Polymer After the Preparation of the Last Segment of the Selectively Hydrogenated Block Copolymer

In this approach, the synthesis of the selectively hydrogenated block copolymer is completed and the living chain ends of the base block copolymer are terminated optionally by coupling, protonation, reaction with a capping agent, or chain transfer to an initiating species. At this point in the preparation, polymerization is reinitiated by addition of a suitable amount of initiating agent (could be in part or in total an activated chain transfer species). Sufficient monoalkenyl arene monomer is added to complete the polymerization of the APS whereupon a terminating agent is added to complete the polymerization process. This approach has advantages similar to those outlined in the first example above, with the caveat that the preparation of the selectively hydrogenated block copolymer may be more straightforward (not contaminated with terminating agents and things of that sort). The blend of the APS and the selectively hydrogenated block copolymer could then be recovered from the solvent using any of the methods that are standard for the recovery of the selectively hydrogenated block copolymer.

6. Hydrogenation Step

After polymerization, the selectively hydrogenated block is hydrogenated. The preferred hydrogenation is selective hydrogenation of the diene portions of the final block copolymer. Hydrogenation generally improves thermal stability, ultraviolet light stability, oxidative stability, and, therefore, weatherability of the final polymer. Hydrogenation can be carried out via any of the several hydrogenation or selective hydrogenation processes known in the prior art. For example, such hydrogenation has been accomplished using methods such as those taught in, for example, U.S. Pat. Nos. 3,595,942; 3,634,549; 3,670,054; 3,700,633; and Re. 27,145, the disclosures of which are incorporated herein by reference. These methods operate to hydrogenate polymers containing aromatic or ethylenic unsaturation and are based upon operation of a suitable catalyst. Such catalyst, or catalyst precursor, preferably comprises a Group VIII metal such as nickel or cobalt which is combined with a suitable reducing agent such as an aluminum alkyl or hydride of a metal selected from Groups I-A, II-A and III-B of the Periodic Table of the Elements, particularly lithium, magnesium or aluminum. This preparation can be accomplished in a suitable solvent or diluent at a temperature from about 20° C. to about 80° C. Other catalysts that are useful include titanium based catalyst systems.

Hydrogenation can be carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. Such exhaustive hydrogenation is usually achieved at higher temperatures. In that case, the double bonds of both the conjugated diene and arene may be reduced by 90 percent or more.

Once the hydrogenation is complete, it is preferable to extract the catalyst by stirring with the polymer solution a relatively large amount of aqueous acid (preferably 20-30 percent by weight), at a volume ratio of about 0.5 parts aqueous acid to 1 part polymer solution. Suitable acids include phosphoric acid, sulfuric acid and organic acids. This stirring is continued at about 50° C. for about 30 to about 60 minutes while sparging with a mixture of oxygen in nitrogen. Care must be exercised in this step to avoid forming an explosive mixture of oxygen and hydrocarbons.

As described above, the selectively hydrogenated block copolymer can be independently hydrogenated, and then blended with the solution containing the monoalkenyl arene polymer prior to solvent removal, or blended post polymerization and hydrogenated in a single batch. In addition, it is possible to use an unhydrogenated monoalkenyl arene polymer with the selectively hydrogenated block copolymer. Further, the rubber softening modifier and other components such as antioxidants and the like can be added prior to finishing.

7. Finishing Step

The last step, following all polymerization(s) as well as the hydrogenation step, is a finishing treatment to remove the final polymers from the solvent. Various means and methods are known to those skilled in the art, and include use of steam to evaporate the solvent, and coagulation of the polymer followed by filtration. The final result is a “clean” block copolymer composition useful for a wide variety of challenging applications, according to the properties thereof.

8. Process for Making Films

The invention of the present invention relates specifically to the process for making films having improved tear resistance. While films based on S-EB-S block copolymers in the past have had good elastic properties, for example good hysteresis recovery, low permanent set, and good tensile properties when measured by standard ASTM tests without defects, or notches, they inherently have poor tear strength when notched, especially at high speeds>1 meter/second. The process of the invention comprises (a) blending 40 to 80 parts by weight of the composition comprising a selectively hydrogenated block copolymer and 5 to 30 parts by weight of a monoalkenyl arene polymer prepared by anionic polymerization with 0 to 50 parts by weight of a rubber softening modifier, and (b) extruding an elastic film from the resulting blend at a temperature of 180° to 300° C., wherein the resulting film has a Rupture Energy over 10 kJ/m³×1000, and a Tensile Strength more than 6 MPa according to the Lesser high speed tensile test using a notched sample. This process can be carried out in at least three ways:
1. The 40 to 80 parts by weight of the composition comprising a selectively hydrogenated block copolymer and 5 to 30 parts by weight of a monoalkenyl arene polymer prepared by anionic polymerization can be blending with the 0 to 50 parts by weight of a rubber softening modifier in a mixer, such as a Henschel Mixer or a simple drum tumbler. This mixture can then be fed into a film extruder which can be a single screw extruder, or a twin screw extruder fixed with a film die to directly extrude the film. The film die can be any die commonly used for elastic or plastic films including coat-hanger and fish-tail designs. Typically the film will be cast onto a chill roll to control thickness and flatness. It may be further calendared, embossed or otherwise processed to change its surface texture or introduce holes that allow free passage of air through the film.
2. Alternately, the 40 to 80 parts by weight of the composition comprising a selectively hydrogenated block copolymer and 5 to 30 parts by weight of a monoalkenyl arene polymer prepared by anionic polymerization can be blending with the 0 to 50 parts by weight of a rubber softening modifier in a mixer, such as a Henschel Mixer or a simple drum tumbler. This mixture can be pelletized using a single screw or twin screw extruder. The pellets from this extrusion are then dried and fed into a film extruder to make the final film.
3. Alternately, the 40 to 80 parts by weight of the composition comprising a selectively hydrogenated block copolymer and 5 to 30 parts by weight of a monoalkenyl arene polymer prepared by anionic polymerization can be fed into a twin screw extruder and 0 to 50 parts by weight of a rubber softening modifier can be injected into the melt to form the final composition. The melt can then be pelletized for later film extrusion or directly extruded as the final film.

9. Other End-Uses and Applications

The polymer compositions of the present invention are useful in a wide variety of applications. The following is a partial list of the many potential end uses or applications: fibers, over molding, personal hygiene, molded and extruded goods, barrier films, packaging, closures such as synthetic corks and cap seals, tubing, footwear, containers including containers for food or beverages, interior automotive applications, window gaskets, oil gels, foamed products, fibers including bicomponent and monofilament, adhesives, cosmetics and medical goods. The preferred end uses are for elastic films and fibers used in personal care applications such as diapers, training pants, adult incontinence products, etc., where the tear resistance, strength, hysteresis recovery, and stress relaxation are most important.

Finally, the copolymer compositions of the present invention can be compounded with other components not adversely affecting the copolymer properties. Exemplary materials that could be used as additional components would include, without limitation, pigments, antioxidants, stabilizers, surfactants, waxes, flow promoters, traditional processing oils, solvents, particulates, and materials added to enhance processability and pellet handling of the composition. In addition, the copolymer compositions can be further formulated with other polymers, including by way of illustration and not limitation, polyolefins (e.g., propylene homopolymers and copolymers, ethylene homopolymers and copolymers and butylene homopolymers and copolymers), polystyrenes, polyurethanes, polyamides, polyesters, functionalized polymers (e.g., maleated PP, maleated S-EB-S), styrene diene block copolymers (e.g. S-I-S, S-B-S, S-I/B-S) hydrogenated styrene diene block copolymers (e.g. S-EB-S, S-EP-S, S-EP, S-EB) and the like.

For personal care applications, rubber softening modifiers are often added. Examples of the rubber softening modifiers include paraffin-based processing oil, naphthene-based processing oil, white oil, mineral oil, oligomers formed from ethylene and α-olefins, paraffin wax, liquid paraffin and tackifying resins. These rubber softening modifiers may be used either individually or in combinations of two or more. Of these, paraffin-based processing oil and hydrogenated tackifying resins are particularly preferred. These oils include Drakeol 34, Primol 352 and the like while the tackifying resins include Oppera 100, Regalrez 1126 and the like. The resulting compounds are preferred, as shown in Table #1 below:

TABLE #1
Compounds for Personal Care

| Component Amounts, ppw | Broad | Preferred |
|---|---|---|
| Selectively Hydrogenated Block Copolymer | 40 to 80 | 50 to 70 |
| Anionic Polystyrene | 5 to 50 | 5 to 30 |
| Rubber Softening Modifier | 0 to 50 | 10 to 35 |

The following Examples are intended to be illustrative only, and are not intended to be, nor should they be construed as being, limitative in any way of the scope of the present invention.

Table #2 below lists the various selectively hydrogenated block copolymers used in the Examples:

TABLE 2
Selectively Hydrogenated Block Copolymers (SHBC)

G-1650-Selectively hydrogenated S-EB-S block copolymer with 30% w.
styrene content, and a vinyl content of butadiene prior to hydrogenation of
38%, as supplied by KRATON Polymers, and meeting the molecular
weight limits as noted in the claims.
G-1660-Selectively hydrogenated S-EB-S block copolymer with 31% w.
styrene content, vinyl content of butadiene prior to hydrogenation of
38%, as supplied by KRATON Polymers, and meeting the molecular
weight limits as noted in the claims.
RP-6924-Selectively hydrogenated S-EB-S, as supplied by KRATON
Polymers, and meeting the molecular weight limits as noted in the claims.
EDF-8995-Selectively hydrogenated S-EB-S, as supplied by KRATON
Polymers, and meeting the molecular weight limits as noted in the claims.
RP-6936-Selectively hydrogenated S-EB-S, as supplied by KRATON
Polymers, and meeting the molecular weight limits as noted in the claims.
Septon 4033-Selectively hydrogenated S-EB/EP-S, as supplied by Septon
Company of America, and meeting the molecular weight limits as noted
in the claims.

### EXAMPLE 1

In this example, various monoalkenyl arene homopolymers were prepared. An appropriate amount of cyclohexane (purified with Alcoa alumina) was charged to a stainless steel reactor vessel and heated to 50° C. A calculated amount of sec-butyl lithium was charged, immediately followed by an amount of purified and stripped styrene. After a reaction time a calculated amount to consume >99.9% of the styrene monomer methanol was added to terminate the polymer. Polymers were made with 10,000; 14,000; 50,000 and 100,000 molecular weight. All had a polydispersity (Q) less than 1.2.

### EXAMPLE 2

Various blends of monoalkenyl arene homopolymers, selectively hydrogenated block copolymers, and softening agents were prepared according to the following general procedure: 195 pounds of cyclohexane, 32 pounds of Kraton G1660 crumb, a selectively hydrogenated block copolymer and 40 pounds of a solution containing 80% cyclohexane and 20% of a 14,000 mw APS (thus a total of 8 pounds of the APS) were added to a Cowles high shear dissolver, along with a certain amount of, in order to form a solution containing about 15% weight solids. The resulting mixture was then heated to about 90° C., and allowed to mix at about 1400 RPM for 60 to 120 minutes. The solvent was then stripped in a cyclone and the blend recovered as crumb. The crumb, or other crumb containing other APS polymers, was dry blended with Drakeol 34 oil and pelletized using a Berstorff twin screw extruder. The composition of the various blends is shown below in Tables #3 and 4. Films were extruded using a Davis Standard single screw extruder fitted with a 10″ coat-hanger die onto a chill roll. The die temperature was typically about 230° C. The films were collected on a roll and tested using an Instron Tension frame to generate the data in Tables #3 and 4. The relative amounts are listed by parts per weight (“ppw”).

TABLE #3

| | 1 | 2 | 3 | 4 | 5 | 6 | 7 | 8 | 9 |
|---|---|---|---|---|---|---|---|---|---|
| G1660, ppw | 60 | 56 | 52 | 60 | 56 | 52 | 60 | 56 | 52 |
| Oil, ppw | 25 | 30 | 35 | 25 | 30 | 35 | 25 | 30 | 35 |
| Anionic PS, ppw | 15 | 14 | 13 | 15 | 14 | 13 | 15 | 14 | 13 |
| Anionic PS MW | 100,000 | 100,000 | 100,000 | 50,000 | 50,000 | 50,000 | 14,000 | 14,000 | 14,000 |
| AO330, ppw | 0.1 | 0.1 | 0.1 | 0.1 | 0.1 | 0.1 | 0.1 | 0.1 | 0.1 |
| Irgaphos 168, ppw | 0.2 | 0.2 | 0.2 | 0.2 | 0.2 | 0.2 | 0.2 | 0.2 | 0.2 |
| Tensile Data | | | | | | | | | |
| 50% Modulus | 96 | 82 | 63 | 92 | 83 | 65 | 103 | 84 | 65 |
| 100% Modulus | 123 | 109 | 85 | 125 | 116 | 88 | 132 | 111 | 88 |
| 300% Modulus | 283 | 244 | 181 | 310 | 269 | 212 | 267 | 219 | 172 |
| Stress at Break | 2983 | 2313 | 1602 | 4994 | 4100 | 3062 | 3011 | 3156 | 2079 |
| Elongation at | 836 | 893 | 926 | 8.7 | 9.2 | 10.2 | 869 | 1019 | 1087 |
| Break % | | | | | | | | | |
| 200% Hysteresis | | | | | | | | | |
| Max Stress | 217 | 199 | 163 | 190 | 161 | 135 | 187 | 167 | 163 |
| % Energy | 89 | 90 | 91 | 88 | 89 | 88 | 90 | 90.5 | 92 |
| Recovery | | | | | | | | | |
| Permanent Set % | 4.8 | 3.6 | 6 | 1.7 | 2 | 4.4 | 4.8 | 6.2 | 6.9 |
| Notched Tensile | | | | 9.04 | | 6.76 | | | |
| Strength (MPa) | | | | | | | | | |
| Energy to Rupture | | | | 14.9 | | 14 | | | |
| (KJ/M³ × 1000) | | | | | | | | | |

TABLE #4

| | 10 | 11 | 12 | 13 | 14 | 15 |
|---|---|---|---|---|---|---|
| G1660, ppw | 60 | 56 | 52 | 63.75 | 59.5 | 55.25 |
| Oil, ppw | 25 | 30 | 35 | 25 | 30 | 35 |
| Anionic PS, ppw | 15 | 14 | 13 | 11.25 | 10.25 | 9.75 |
| Anionic PS MW | 10,000 | 10,000 | 10,000 | 10,000 | 10,000 | 10,000 |
| AO330, ppw | 0.1 | 0.1 | 0.1 | 0.1 | 0.1 | 0.1 |
| Irgaphos 168, ppw | 0.2 | 0.2 | 0.2 | 0.2 | 0.2 | 0.2 |
| Tensile Data | | | | | | |
| 50% Modulus | 123 | 110 | 89 | 93 | 92 | 86 |
| 100% Modulus | 155 | 138 | 116 | 119 | 118 | 111 |
| 300% Modulus | 292 | 259 | 206 | 232 | 231 | 214 |
| Stress at Break | 3190 | 3018 | 2314 | 2547 | 2726 | 2340 |
| Elongation at Break % | 1052 | 1022 | 1162 | 934 | 972 | 1031 |
| 200% Hysteresis | | | | | | |
| Max Stress | 1.229 | 1.144 | 0.994 | 1.1 | 1.078 | 0.886 |
| % Energy Recovery | 80 | 82 | 87 | 89.2 | 90.22 | 92.7 |
| Permanent Set % | 6.31 | 5.4 | 4.8 | 3.25 | 3.54 | 3.28 |
| Notched Tensile | | | | | | |
| Strength (MPa) | | | | | | |
| Energy to Rupture | | | | | | |
| (KJ/M³ × 1000) | | | | | | |

### EXAMPLE 3

In this comparative example, blends were made with crystal polystyrene, as opposed to anionic polystyrene. The results are shown in Table 5 below:

TABLE #5

| | 16 | 17 | 18 | 19 | 20 | 21 | 22 | 23 |
|---|---|---|---|---|---|---|---|---|
| G1660. ppw | 60 | 60 | | | | | | |
| G1650, ppw | | | 60 | 60 | | | | |
| Septon 4033, ppw | | | | | 60 | 60 | | |
| EDF8995, ppw | | | | | | | 90 | 80 |
| Oil, ppw | 25 | 31 | 25 | 31 | 25 | 31 | 10 | 10 |
| Crystal PS, ppw | 15 | 9 | 15 | 9 | 15 | 9 | | 10 |
| AO330, ppw | 0.1 | 0.1 | 0.1 | 0.1 | 0.1 | 0.1 | 0.1 | 0.1 |
| Irgaphos 168, ppw | 0.2 | 0.2 | 0.2 | 0.2 | 0.2 | 0.2 | 0.2 | 0.2 |
| Tensile Data | | | | | | | | |
| 50% Modulus | 102 | 71 | 69 | 62 | 117 | 61 | 170 | 198 |
| 100% Modulus | 134 | 97 | 96 | 86 | 148 | 81 | 222 | 252 |
| 300% Modulus | 347 | 251 | 278 | 222 | 330 | 195 | 438 | 596 |
| Stress at Break | 3912 | 3260 | 3757 | 3378 | 3900 | 2592 | 6398 | 3862 |
| Elongation at Break % | 8.3 | 9.2 | 8.1 | 9.5 | 7.8 | 8 | 7.9 | 6.7 |
| 200% Hysteresis | | | | | | | | |
| Max Stress | 183 | 157 | 154 | 135 | 141 | 150 | 242 | 337 |
| % Energy Recovery | 87 | 90 | 83 | 86 | 85 | 86 | 83 | 81 |
| Permanent Set % | 3 | 2.6 | 6.28 | 6.5 | 7 | 7.47 | 6.1 | 5.9 |
| Notched Tensile | | 3.99 | | 3.63 | | 2.54 | | |
| Strength (MPa) | | | | | | | | |
| Energy to Rupture | | 9.26 | | 8.27 | | 7.92 | | |
| (KJ/M³ × 1000) | | | | | | | | |

As shown in the above Tables 3-5, the compounds with the anionic polystyrene have much higher energies to rupture and strengths than compounds made with crystal polystyrene. Significantly, Comparative Example 18, made with crystal polystyrene, had an Elmendorf tear value of 360 grams force, whereas the Examples 1-3 and 7-9 made with anionic polystyrene had a range of Elmendorf tear of 800 to over 1000 grams force, much improved over compounds with crystal polystyrene. The examples according to the invention also have lower odor. While the compounds made with 10,000 mw anionic polystyrene have good properties, their extrusion was poor, showing that a range of over 1.2 to 1 for the molecular weight of the anionic polystyrene to the styrene end block is significant and important in obtaining the best property balance.

1. A process for improving the tear resistance of plastic films comprising (i) blending 40 to 80 parts by weight of a selectively hydrogenated block copolymer, 5 to 30 parts by weight of a monoalkenyl arene polymer prepared by anionic polymerization and 0 to 50 parts by weight of a rubber softening modifier, and (ii) extruding an elastic film from the resulting blend composition at a temperature of 1800 to 3000° C. and a viscosity of 10,000 to 1,000,000 Pa-sec at extrusion temperature, wherein the resulting film has a Rupture Energy over 10 kJ/m³×1000, and a Tensile Strength more than 6 MPa measured at 4 meters/second with a notch using a high speed tensile test, and wherein:
(a) said selectively hydrogenated block copolymer has the general configuration A-B-A, A-B-A-B, (A-B)ₙ, (A-B-A)ₙ, (A-B-A)ₙX, (A-B)ₙX or mixtures thereof, where n is an integer from 2 to about 30, and X is coupling agent residue, which polymer is prepared by anionic polymerization and wherein:
(i) prior to hydrogenation each A block is a mono alkenyl arene polymer block and each B block is a conjugated diene block having a vinyl content (V) between 5 weight percent and 85 weight percent;
(ii) subsequent to hydrogenation about 0 -10% of the arene double bonds have been reduced, and at least about 90% of the conjugated diene double bonds have been reduced;
(iii) each A block having a number average molecular weight between about 3,000 and about 20,000 and each B block or coupled B block having a number average molecular weight between about 20,000 and about 200,000; and
(iv) the total amount of mono alkenyl arene in the hydrogenated block copolymer is about 10 percent weight to about 40 percent weight;
(b) said monoalkenyl arene polymer is prepared by anionic polymerization wherein:
(i) said monoalkenyl arene polymer has a number average molecular weight of 5,000 to 200,000;
(ii) said monoalkenyl arene polymer has a number average molecular weight that is greater than 1.2 times the number average molecular weight of the A block; and
(iii) said monoalkenyl arene polymer has a molecular weight distribution between 1 and 1.5 wherein the weight average molecular weight (MW_{w}) is divided by the number average molecular weight (MWₙ); and
(c) said selectively hydrogenated block copolymer, said monoalkenyl arene polymer, and said rubber softening modifier totaling 100 parts by weight; and
(d) wherein said selectively hydrogenated block copolymer is prepared in solution in the presence of a solvent in a first reactor to form a first solution and said monoalkenyl arene polymer is prepared in solution in the presence of a solvent in a second reactor to form a second solution, or said selectively hydrogenated block copolymer is polymerized prior to or during the addition of said monoalkenyl arene polymer solution, wherein hydrogenation of said selectively hydrogenated block copolymer and said monoalkenyl arene polymer is selectively performed either prior or subsequent to addition of said monoalkenyl arene polymer solution;
(e) said first and second solutions are combined to form a common solution; and
(f) the solvent is removed from the common solution, providing an intimate mixture of said selectively hydrogenated block copolymer and said monoalkenyl arene polymer.

2. The process according to claim 1 wherein said mono alkenyl arene for the selectively hydrogenated block copolymer and said monoalkenyl arene polymer is selected from styrene, alpha-methyl styrene and mixtures thereof and wherein said conjugated diene for the selectively hydrogenated block copolymer is selected from the group consisting of isoprene, 1,3-butadiene and mixtures thereof.

3. The process according to claim 2 wherein said conjugated diene is 1,3-butadiene and wherein about 20 to about 80 mol percent of the condensed butadiene units in block B have 1,2-configuration prior to hydrogenation.

4. The process according to claim 2 wherein said selectively hydrogenated block copolymer is selected from the group consisting of (i) block copolymers having an overall structure A-B-A, said block A having a molecular weight of between 5,000 and 20,000, said block B having a molecular weight of between 20,000 and 200,000, and (ii) block copolymers having an overall structure (A-B)nX where n is between 2 and 6, said block A having a molecular weight of between 5,000 and 20,000, said block B prior to coupling having a molecular weight of between 10,500 and 100,000, and wherein said monoalkenyl arene polymer has a number average molecular weight of between 8,000 and 100,000.

5. The process according to claim 4 wherein said rubber softening modifier is selected from paraffin-based processing oil, naphthene-based processing oil, white oil, mineral oil, oligomers formed from ethylene and α-olefins, paraffin wax, and liquid paraffin.

6. The process according to claim 5 wherein said rubber softening modifier is a paraffin-based processing oil.

7. The process according to claim 2 wherein said first solution and second solution are combined after polymerization of both the selectively hydrogenated block copolymer and the monoalkenyl arene polymer, and prior to hydrogenation, and said common solution is hydrogenated.

8. The process according to claim 2 wherein said first solution and second solution are combined after hydrogenation of the selectively hydrogenated block copolymer and prior to finishing.

9. The process according to claim 2 wherein said second solution is added to said first solution prior to polymerization of said selectively hydrogenated block copolymer.

10. The process according to claim 2 wherein said second solution is added to said first solution during the polymerization of said selectively hydrogenated block copolymer.

11. The process of claim 5 wherein said monoalkenyl arene polymer has a total residual monomer and dimer content less than 0.1 weight percent.

12. A process for improving the tear resistance of elastic films comprising (i) blending 40 to 80 parts by weight of a selectively hydrogenated block copolymer, 5 to 30 parts by weight of a monoalkenyl arene polymer prepared by anionic polymerization and 0 to 50 parts by weight of a rubber softening modifier, and (ii) extruding a plastic film from the resulting blend composition at a temperature of 180° to 300° C. and a viscosity of 10,000 to 1,000,000 Pa-sec at extrusion temperature, wherein the resulting film has a Rupture Energy over 10 kJ/m3×1000, and a Tensile Strength more than 6 MPa when measured at 4 meters/second with a notch using a high speed tensile test, and wherein:
(a) said solid selectively hydrogenated block copolymer has the general configuration A-B-A, A-B-A-B, (A-B)ₙ, (A-B-A)ₙ, (A-B-A)ₙX, (A-B)ₙX or mixtures thereof, where n is an integer from 2 to about 30, and X is coupling agent residue and wherein:
(i) prior to hydrogenation each A block is a mono alkenyl arene polymer block and each B block is a selectively hydrogenated polymer block of at least one conjugated diene;
(ii) subsequent to hydrogenation about 0-10% of the arene double bonds have been reduced, and at least about 90% of the conjugated diene double bonds have been reduced;
(iii) each A block having a peak molecular weight between about 3,000 and about 20,000 and each B block or coupled block B having a peak molecular weight between about 20,000 and about 200,000; and
(iv) the total amount of mono alkenyl arene in the hydrogenated block copolymer is about 10 percent weight to about 40 percent weight; and
(b) said monoalkenyl arene polymer is prepared by anionic polymerization wherein:
(i) said monoalkenyl arene polymer has a number average molecular weight of 5,000 to 200,000;
(ii) said monoalkenyl arene polymer has a number average molecular weight that is greater than 1.2 times the number average molecular weight of the A block; and
(iii) said monoalkenyl arene polymer has a molecular weight distribution between 1 and 1.5 wherein the weight average molecular weight (MWw) is divided by the number average molecular weight (MWₙ); and
(c) the total blend composition contains 100 parts by weight; and
(d) wherein said block copolymer is formed in solution in a reactor in the presence of a solvent and said monoalkenyl arene polymer is formed in the same solution in the same reactor; and
(e) wherein the solution is selectively hydrogenated to remove >90% of the double bonds in the polydiene block; and
(f) the solvent is removed from the solution, providing an intimate mixture of said selectively hydrogenated block copolymer and said monoalkenyl arene polymer.

13. The process according to claim 12 wherein said mono alkenyl arene for the selectively hydrogenated block copolymer and said monoalkenyl arene polymer is selected from styrene, alpha-methyl styrene and mixtures thereof and wherein said conjugated diene for the selectively hydrogenated block copolymer is selected from the group consisting of isoprene, 1,3-butadiene and mixtures thereof.

14. The process according to claim 13 wherein said conjugated diene is 1,3-butadiene and wherein about 20 to about 80 mol percent of the condensed butadiene units in block B have 1,2-configuration prior to hydrogenation.

15. The process according to claim 13 wherein said selectively hydrogenated block copolymer is selected from the group consisting of (i) block copolymers having an overall structure A-B-A, said block A having a molecular weight of between 5,000 and 20,000, said block B having a molecular weight of between 20,000 and 200,000, and (ii) block copolymers having an overall structure (A-B)ₙX where n is between 2 and 6, said block A having a molecular weight of between 5,000 and 20,000, said block B prior to coupling having a molecular weight of between 10,000 and 100,000, and wherein said monoalkenyl arene polymer has a number average molecular weight of between 10,000 and 200,000.

16. The process according to claim 13 wherein said rubber softening modifier is selected from paraffin-based processing oil, naphthene-based processing oil, white oil, mineral oil, oligomers formed from ethylene and α-olefins, paraffin wax, and liquid paraffin.

17. The process according to claim 13 wherein said rubber softening modifier is a paraffin-based processing oil,

18. The process according to claim 12 wherein said monoalkenyl arene polymer is polymerized prior to said selectively hydrogenated block copolymer.

19. The process according to claim 12 wherein said monoalkenyl arene polymer is polymerized after said selectively hydrogenated block copolymer.

20. The process of claim 16 wherein said monoalkenyl arene polymer has a total monomer and dimer content less than 0.1 weight percent.

21. The process of claim 1 wherein said blend composition also contains at least one component selected from the group consisting of fillers, reinforcements, tackifying resins, lubricants, stabilizers, antioxidants, styrene/diene block copolymers and polyolefins.

22. The process of claim 12 wherein said blend composition also contains at least one component selected from the group consisting of fillers, reinforcements, tackifying resins, lubricants, stabilizers, antioxidants, styrene/diene block copolymers and polyolefins.

23. Elastic films formed by the process of claim 1.

24. The films according to claim 23, wherein said films are used in personal care applications.

25. Elastic films formed by the process of claim 12.
